(19) United States
(12) Patent Application Publication
(10) Pub. No.: US 2025/0013487 A1
(43) Pub. Date: Jan. 9, 2025

(54) APPARATUS AND A METHOD AND A NON-TRANSITORY MACHINE-READABLE STORAGE MEDIUM

(71) Applicants: Vincent SCARLATA, Beaverton, OR (US); James BEANEY, JR., Raleigh, NC (US); Bin XING, Hillsboro, OR (US); Ned M. SMITH, Beaverton, OR (US)

(72) Inventors: Vincent SCARLATA, Beaverton, OR (US); James BEANEY, JR., Raleigh, NC (US); Bin XING, Hillsboro, OR (US); Ned M. SMITH, Beaverton, OR (US)

(21) Appl. No.: 18/896,647

(22) Filed: Sep. 25, 2024

Related U.S. Application Data
(60) Provisional application No. 63/648,213, filed on May 16, 2024.

(51) Int. Cl. G06F 9/455; H04L 9/30

(52) U.S. Cl. CPC G06F 9/45558; H04L 9/3073; G06F 2009/45587

(57) ABSTRACT

It is provided an apparatus comprising interface circuitry, machine-readable instructions, and processing circuitry to execute the machine-readable instructions. The machine-readable instructions include instructions to generate first attestation evidence based on a measurement of the system software proving the integrity of a system software running on the processing circuitry based on a root of trust of the processing circuitry. The machine-readable instructions further include instructions to generate second attestation evidence for verifying the integrity of a first confidential computing environment based on a measurement of the first confidential computing environment and on the generated first attestation evidence. The first confidential computing environment is operating on the system software and is executed by the processing circuitry. The first confidential computing environment is a virtual machine environment.

### BACKGROUND

Secure execution technologies may in some cases use a common attestation client for isolated execution environments to ensure their integrity and security. However, virtual machines (VMs) typically rely on a variety of chipset solutions, such as hardware-based security modules or virtualized security modules, which can lead to inconsistencies and complexities in the attestation process. This fragmentation in attestation mechanisms for VMs, compared to the more unified approach for other secure environments, poses challenges in maintaining a consistent and robust security posture across different types of execution environments.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus or device;

FIG. 2 illustrates a flowchart of an example of a method;

FIG. 3 illustrates a trusted platform hierarchy;

FIG. 4 illustrates attested components within a trusted platform hierarchy; and

FIG. 5 illustrates a remote attestation of a trusted platform hierarchy.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

In previous approaches, confidential computing environments such as Intel® software guard extensions (SGX) and Intel® trusted domain extensions (TDX) use a common attestation client for their enclaves (SGX) and trusted domains (TDX). The attestation for virtual machines however may often depend on chipset solutions such as trusted platform module (TPM), embedded security element (ESE), or virtual TPMs. For example, SGX and TDX differ from a virtualization technology such as Intel® Virtualization Technology (VT-x) in that the latter may not provide isolated execution that is based on the same level of security (e.g., memory encryption, and IO isolation via TDX-Connect). However, that difference doesn't mean the attestation capability must also differ.

The proposed technique extends the quoting trusted domain (TD) of the TDX confidential computing environment to interface directly with microcode/extended microcode (xCode/xuCode) to both collect measurements of a VM, produce an authenticated local attestation report for consumption by a local confidential computing environment (such as a trusted execution environment (TEE)), and a signed attestation report (which may comprise or be referred to as attestation evidence) for consumption by a remote verifier (e.g. Intel® Trust Authority). That is, the proposed technique may extend the attestation capability, for example of the TDX to VMs, by exposing a uCode/xuCode interface for obtaining local measurements of the VM and by exposing an interface to a quoting environment (QE) (e.g., Quoting TD). For example, existing secure/attested boot architecture for confidential computing may be leveraged to measure a virtual machine monitor (VMM) such that a device identifier composition engine (DICE) layering may be common for TDX, SGX and VTX. Cloud/Edge applications (such as containers) hosted locally may obtain attestation reports about other containers even when the container is a VM container.

A corresponding QE may sign attestation measurement for any target environment (i.e., SGX enclave, TDX domain or VTX VM). A remote attestation verifier may scale better because there is a common approach to attestation evidence creation for any workload deployed to the same platform. The evidence format is consistent for all target environments (enclave, domain, VM), but the veracity may differ.

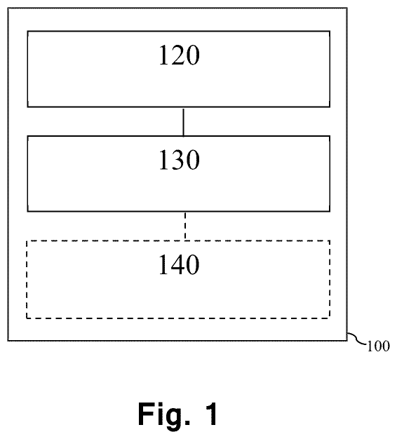

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to generate a first attestation evidence based on a measurement of a system software proving the integrity of the system software running on the processing circuitry 130 based on a root of trust of the processing circuitry 130. The root of trust (RoT) of the processing circuitry is a secure, foundational hardware component embedded within the processing circuitry 130 itself, establishing a trusted computing base for the computing system in which it is included. The ROT may provide critical security functions such as secure boot, cryptographic key management, and attestation to ensure system integrity. The ROT may have a unique device ID key, for example certified by the processing circuitry manufacturer, linking the hardware processing circuitry to this unique verified ID. The ROT may be part of one or more CCEs, like the first and/or second CCE. That is it may serve as a common ROT for a plurality of CCEs.

The processing circuitry 130 may be part of a trusted platform. A trusted platform may be a hierarchically organized integrated computing system comprising hardware, firmware and/or software components designed to establish and maintain a secure computing environment. It may include the RoT of the processing circuitry 130, firmware, one or more confidential computing environments, trusted platform manager, and/or other critical elements that work together to enforce security policies, perform secure boot processes, generate and manage cryptographic keys, and collect and verify measurements and attestation reports. The trusted platform manager may manage the plurality of different confidential computing environments (such as enclaves, trusted domains, and virtual machines), ensuring the security and integrity of each environment within the platform.

In some examples, the system software may refer to or comprise a firmware such as a BIOS/UEFI or a bootloader or an operating system kernel or the like. The ROT may receive a measurement of the system software, such as the BIOS and initial software loaded during boot.

In some examples, the system software may refer to the trusted platform manager (also referred to as TEE trusted platform (TTP)) running on the processing circuitry 130. The trusted platform manager may manage the security of a plurality of confidential computing environments (CCEs). It may perform secure boot processes, generate, and manage cryptographic keys, and collect and verify measurements and attestation reports for the plurality of CCEs. The trusted platform manager may be a logical layer. The trusted platform manager may comprise various logical components, such as a trusted execution environment (TEE), and layers that work together to establish a robust chain of trust. These components include secure boot processes, cryptographic keys, and specialized microcode instructions that perform measurements and generate attestation reports, ensuring the integrity and authenticity of the protected environments. For example, the trusted platform manager may operate by loading an initial image into a protected memory region such as an enclave, trusted domain, or virtual machine. The trusted platform manager may use microcode instructions to scan the memory and produce a digest, included in a report for the target environment. This initial image can extend the region by loading additional components and computing integrity digests for these extended images.

A measurement may represent the state of a software and/or hardware component of the CCE at a specific point in time. For example, a measurement may be a digest that represents the state of any software and/or hardware component of the CCE at that specific point in time. A measurement of a software (including firmware) component may comprise a cryptographic hash of the software. This hash may include the binary executable code, configuration data, initial state data and/or AI models, AI training data, AI pipeline of that software or software component. The hash is generated by reading the raw binary data of the system software components and processing it through a cryptographic hash function (e.g., SHA-256) to produce a fixed-size hash value that uniquely represents the exact state of the component at that point in time. For example, the measurement of the system software (also referred to as a claim) may comprise an image of the system software. The measurement of the system image may include a cryptographic hash of the binary executable code, configuration data, and initial state data of the system software or system software components, such as the BIOS/UEFI, bootloader, and operating system kernel.

Attestation evidence for verifying the integrity of a CCE may be a comprehensive set of data used to verify the integrity and security of a CCE and/or one or more of its layered environments. The attestation evidence may be used in an attestation process to provide verifiable proof to a verifier that the CCE and/or its components are secure, untampered with, and operating as expected, allowing the verifier to establish trust in the CCE's integrity and security status. Generating attestation evidence may comprise creating a cryptographic hash of the component's state (measurement) and then signing this hash with a private key to produce a digital signature, ensuring the integrity and authenticity of the measurement. Attestation evidence may comprise the measurement and the cryptographic signature of the measurement.

In some examples, generating the first attestation evidence may involve signing the measurement of the system software with a first private key. This first private key may be based on the root of trust (ROT) of the processing circuitry. The ROT, which is part of the processing circuitry, may receive the measurements of the system software and then verify these measurements, for example, by comparing the hash to a predetermined and stored hash value. If the measurement of the system software is valid, the ROT (i.e., the processing circuitry) may sign the verified measurement with the first private key, forming part of the first attestation evidence. Signing the measurement with the private key involves creating a digital signature for the measurements. This process uses the private key to encrypt the hash, producing a unique digital signature. The digital signature, which is the encrypted hash, ensures the authenticity and integrity of the measurement. The first attestation evidence may then comprise the measurement of the system software and the digital signature. The first private key of the ROT may be hardcoded and based on the unique device ID or compound device identifier which may include measurements of the first attestation evidence as input to a key generation algorithm that produces the attestation key/key-pair. This first attestation evidence is a secure, verifiable record that reflects the integrity of the system software at a specific point in time.

For example, if the system software is a trusted platform manager running on the processing circuitry 130 then the first attestation evidence may prove the integrity of the trusted platform manager. In some examples, generating the first attestation evidence may comprise signing the measurement of the system software with the first private key. The measurement of the trusted platform manager may be received by a firmware on which the trusted platform manager is running. The firmware (which is executed by the processing circuitry 130) may receive the measurements of the trusted platform manager and may then verify the measurement of the trusted platform manager, for example by comparing the hash to a predetermined and stored hash value. If the measurement of the trusted platform manager is valid, then the firmware (i.e., the processing circuitry 130) may sign the verified measurement of the system software with the first private key, which may yield the first attestation evidence. The firmware again may generate measurements which may be attested by the ROT with a private key of the RoT. Further, the firmware may sign the first public key with its private key. Because the trusted platform manager's integrity in this example is attested by the firmware, which is attested by the RoT, the first attestation evidence, which is generated by the trusted platform manager, is based on ROT of the processing circuitry 130.

A private-public key pair, also known as asymmetric cryptography or public-key cryptography, is a cryptographic tool used for secure communication and authentication. The private key is kept secret and is used to sign data, creating a digital signature that verifies the data's integrity and origin. The corresponding public key is shared openly and is used to verify the digital signature created by the private key, ensuring that the data has not been tampered with and confirming the identity of the sender. This pair enables secure data exchange and authentication without needing to share the private key, thus maintaining security.

The generated first attestation evidence may be verified by an (external) verifier. For example, the generated first attestation evidence may be verified using the corresponding first public key (for example the RoT's public key or the firmware's public key), to decrypt the first attestation evidence and compare the provided hashes with their own measurements of the system software. If the hashes match, it confirms that the system software has not been altered, thereby proving its integrity.

For example, the system software may also comprise a second private-public key pair. In some examples, generating the first attestation evidence further comprises signing the second public key of the second public-private key pair with the first private key. The second private key may be used to generate the second attestation evidence as described below. That is, for example, the first attestation evidence may then comprise the measurement of the system software, the signature of the measurement, the second public key and/or the signature of second public key. The second private key may be based on the unique device ID or compound device identifier which may include measurements of the second attestation evidence as input to a key generation algorithm that produces the attestation key/key-pair. For example, a secure manufacturing process may collect the measurement values used as input to a key generation method of a ROT key and/or the second private key. Hence the method for ROT key generation and the method for the second private key may be the same.

Further, the processing circuitry 130 is configured generate second attestation evidence for verifying the integrity of a first confidential computing environment based on a measurement of the first confidential computing environment and on the generated first attestation evidence. The first confidential computing environment is operating on the system software and is executed by the processing circuitry. Further, the first confidential computing environment is a virtual machine environment.

A CCE architecture may comprise a combination of specialized hardware and software components designed to protect data and computations from unauthorized access and tampering within a computer system. The CCE architecture may provide secure processing circuitry, which is responsible for executing sensitive workloads in an isolated environment. Additionally, the CCE architecture may provide secure memory, such as a protected region of the computer system's RAM, where sensitive data can be stored during computation. To further safeguard this data, the CCE architecture may provide memory encryption, ensuring that the contents of the system memory are protected even if physical access to the memory is obtained. For example, the CCE architecture may support I/O isolation and secure input/output operations, preventing data leakage during communication between the processing circuitry and peripheral devices. In some examples, the CCE architecture may provide secure storage capabilities of the computer system, such as a secure partition within the system's main storage, dedicated to storing cryptographic keys, sensitive configuration data. This secure storage ensures that critical data remains protected even when at rest. In some examples, the CCE may also comprise separate secure storage components, such as a tamper-resistant storage chip, like an integrity measurement register, to securely store measurements of the CCE and/or critical data associated with the CCE's operation. A host may generate one or more instances of CCEs based on the CCE architecture. The instances of the CCE architecture may be referred to as a CCE (also referred to as a Trusted Execution Environment). The CCE uses its components to enable the secure and isolated execution of workloads. A workload executed in the CCE may include a set of applications, tasks, or processes that are actively managed and protected by these secure hardware components. This includes computational activities that utilize the CCE's resources, including CPU, memory, and storage, to perform their operations. Such activities may involve running applications, processing sensitive data, performing calculations, and managing tasks that require a high level of security and confidentiality. The CCE ensures that these workloads are protected from unauthorized access and tampering by leveraging hardware-based security features and cryptographic measures, thereby maintaining the integrity and confidentiality of the data and processes throughout their execution

The CCE may comprise one or more hierarchical layered environments, each specifically designed to perform distinct computing functions within the CCE. These environments may be categorized based on their roles and responsibilities, ensuring a structured and secure computing framework. An environment of the CCE may comprise one or more modules, each responsible for specific tasks or operations within that environment. A module of an environment of the CCE may be configured to execute particular functions such as initializing the environment, running applications, managing data, performing cryptographic operations, or ensuring the integrity of the environment and its processes. These modules work together within their respective environments to maintain the security, integrity, and confidentiality of the CCE as a whole. For example, there may be one or more foundational environments of the CCE responsible for core security functions, such as the Root of Trust (ROT). The RoT may be a hardware-based security component that provides a secure and immutable trust anchor for the layers above it. The foundational security provides the essential security mechanisms and trust anchors upon which the entire framework is built. The foundational security framework provides the base upon which the entire CCE's security relies. One example of a foundational security framework is the Device Identifier Composition Engine (DICE) specification. DICE is a hardware-based security mechanism that generates unique cryptographic identities and keys based on the initial measurement of a device's hardware and firmware state during boot. DICE comprises a process that derives cryptographic keys at each stage of the boot process. The keys derived based on DICE may be used to derive various cryptographic keys, including firmware keys and quoting keys, which create a chain of trust through layered identities and attestation. DICE may be defined in the specification “DICE Attestation Architecture” by the Trusted Computing Group, Version 1.1, Revision 0.18, Jan. 6, 2024. Further, the foundational environment of the CCE may comprise a trusted platform manager (also referred to as a Trusted Platform Module, or TPM). The trusted platform manager may record measurements of the CCE into an integrity register and manage cryptographic keys to sign measurements for internal verification. The trusted platform manager ensures that the system starts from a trusted state, forming the foundational security upon which the CCE operates.

Another environment within the CCE may be the quoting environment (QE), also known as the quoting agent, which is responsible for gathering, formatting, reformatting, and signing measurements and generating attestation evidence (also referred to as quotes) from other layered environments within the CCE. The QE may comprise modules responsible for handling cryptographic operations, such as formatting and signing the integrity measurements collected from higher layers. For instance, the QE may receive measurements from an execution environment and format or sign them with a cryptographic key to produce attestation evidence. This attestation evidence may be consolidated and structured in a way that can be verified by an external attestation verifier. For example, the CCE may comprise an execution environment (such as a tenant environment (TE)) and a service environment (such as a migration environment (ME)). The execution environment may be a secure, isolated execution space dedicated to running a tenant's (user's) applications, data, and workloads.

In some examples, the one or more layered environments of a CCE (the first and/or second CCE) may comprise at least one of a quoting environment, a tenant environment, or a service environment. The quoting environment may be configured to collect and provide attestation reports that verify the integrity of the CCE. The tenant environment may be configured to execute a workload of the respective CCE. The service environment may be configured to provide additional services such as maintenance, updates, or security monitoring. The service environment may be a migration environment, which handles the secure migration of workloads between different environments within the CCE.

The virtual machine environment is a computing setup in which a virtual machine (VM) runs on the processing circuitry 130 and its physical host machine. The VM operates as an independent instance with its own operating system and application, isolated from other VMs and the host system. This virtual machine environment may be managed by a virtual machine monitor (VMM, also referred to as hypervisor), which leverages hardware-assisted virtualization technology to allocate and manage physical processing circuitry resources efficiently. The VMM ensures that VMs can share the underlying hardware while maintaining isolation and security, allowing multiple operating systems and workloads to run concurrently on a single physical machine. This setup enhances resource utilization, flexibility, and security in computing environment. For example, the hardware-assisted virtualization technology may be Intel® VT-x, which is a set of hardware extensions for x86 processors that improve the efficiency and security of virtualization. VT-x may allow multiple operating systems to run concurrently on a single physical machine by providing hardware assistance to the hypervisor, enabling better management and isolation of VMs. The first confidential computing environment is a virtual machine environment.

In some examples, a measurement of the first confidential computing environment may be a measurement of one or more layered environments of the first confidential computing environment (including the workload executed in the first CCE, software, firmware and/or or hardware of the first CCE). For example, the measurement of the first confidential computing environment may comprise data about a state, behavior, and/or configuration of the of one or more layered environments of the first confidential computing environment (including the workload executed in the first CCE, software, firmware and/or or hardware of the first CCE). In some examples, a measurement of the second confidential computing environment may be a measurement of one or more layered environments of the second confidential computing environment (including the workload executed in the second CCE, software, firmware and/or or hardware of the second CCE). For example, the measurement of the second confidential computing environment may comprise data about a state, behavior, and/or configuration of the of one or more layered environments of the second confidential computing environment (including the workload executed in the second CCE, software, firmware and/or or hardware of the second CCE).

For example, a measurement of the CCE may comprise a digest of an image of the CCE. That is, the measurement of the CCE comprises a cryptographic hash of the binary executable code, configuration data, and initial state data of the CCE or one pr more layered environments of the CCE. If the CCE comprises more than one environment, the measurement of the CCE may refer to a measure of any of these layered environments. For example, if the CCE is a virtual machine environment, the measurement of the virtual machine environment may comprise a cryptographic hash of a VM's executable code, configuration settings, runtime state, virtual hardware settings, and running processes. For example, the measurement may be a measurement of the quoting environment which comprises a cryptographic hash of the attestation reports and the executable code of the quoting processes. For example, the measurement may be a measurement of the tenant environment which may comprise a cryptographic hash of the tenant's workload data, configuration, and execution state. For example, the measurement may be a measurement of the of the service environment (such as a migration environment) which may comprise a cryptographic hash of the migration service code, configuration data, and any state data relevant to the migration process. In some examples, the measurements of the VM environment comprise measurements of the virtual machine monitor (VMM) managing a virtual machine of the virtual machine environment. These measurements may comprise cryptographic hashes of the VMM's binary executable code, configuration data, and runtime state. This ensures the integrity and authenticity of the VMM managing the virtual machine of the VM environment.

In some examples, generating the second attestation evidence comprises signing the measurement of the virtual machine environment with the second private cryptographic key of the second private-public key pair. That is, the system software (executed by the processing circuitry 130) may receive the measurement of the first CCE (the virtual machine environment) and verify the measurement of the first CCE, for example by comparing the hash to a predetermined and stored hash value. If the measurement of the first CCE is valid then the system software may sign the verified measurement with the second private key which may yield the second attestation evidence. Signing the measurement of the first CCE with the second private key may involve creating a digital signature for the measurement of the first CCE. That is the private key may be used to encrypt the hash, producing a unique digital signature. The digital signature, which is the encrypted hash, ensures the authenticity and integrity of the measurement of the first CCE. This second attestation evidence is a secure, verifiable record that reflects integrity of the CCE at a specific point in time. Because the system software's integrity is attested by the first attestation evidence, the second attestation evidence, which is generated by the system software, is also based on the generated first attestation evidence. That is, the signed measurement of the system software can then be verified using the second public key. The second public key again is certified by the first private key, which is based on the RoT. This builds a hierarchy of trust, where all layers may be traced back to the RoT.

If the first CCE may comprise more than one environment, generating the second attestation evidence may comprise signing the measurement of the hierarchically lowest environment of the virtual machine environment with the second private cryptographic key of the second private-public key pair. For example, in this case the first CCE may comprise a fourth private-public key pair. In some examples, the generating the second attestation evidence comprises signing a fourth public key of the fourth private-public key pair. That is, an environment of the first CCE that is hierarchically higher than the lowest environment of the first CCE may transmit measurements to the hierarchically lowest environment of the first CCE, which may then verify the measurement and sign the verified measurement with the fourth private key which may yield a fourth attestation evidence. This process may be repeated for further environments of the first CCE. This builds a hierarchy of trust, where all layers may be traced back to the RoT.

In some examples, the first and/or second attestation evidence comprise a hash value of a software, a signature (of the hashed software), configuration data, telemetry data and/or inference data. In this regard, configuration data may comprise initial settings for the execution of the software image, such as default operational states like tick counters and file descriptor states. Telemetry data may comprise operational metrics available to the running image, such as memory usage, CPU cycles, and power cycles, providing insights into the system's performance. Inference data may comprise operations performed by the software image that relate to the integrity of the environment, such as extending the environment with runtime images. The inference data might include a manifest structure containing a Merkle Tree of digests of the extended images, where the root digest can be provided to the TDX uCode for inclusion in a report, ensuring the integrity of the extended environment.

In some examples, the processing circuitry 130 is further configured to transmit the first and/or second attestation evidence to an external verifier. The verifier may verify the first and/or second attestation evidence. The verifier may be an external verifier, that is external to the computing system of the processing circuitry 130. The verifier may be an entity responsible for validating the authenticity and integrity of the first and/or second attestation evidence. This may involve checking the cryptographic signatures, measurements, configuration data, telemetry, and inference data provided in the attestation evidence to ensure that the software and environment have not been tampered with and are operating as expected.

For example, the verifier may verify the second attestation evidence by using the second public key to decrypt the attestation evidence. This process reveals the measurements of the VM environment. The verifier can then use the first public key to verify the second public key ensuring the integrity of the VM environment. If the certificate is valid, the verifier proceeds to check the VM environment measurements included in the second attestation evidence. Any alterations to the VM environment software would result in a different measurement hash, which would not match the original measurement included in the second attestation evidence. This process ensures a continuous chain of trust tracing back to the RoT, detecting any discrepancies and thereby confirming the integrity and authenticity of the VM environment. An advantage of this technique is that by signing the public key of the VM environment with the private key (of the ROT or which is attested by the RoT), it ensures a comprehensive, verifiable chain of trust across the entire computing stack down to the RoT. This method allows any alterations to be detected at each layer. For example, if the VM environment is altered, the new measurement would produce a different hash, causing a mismatch when verifying the second attestation evidence. Further, this technique allows the attestation mechanism used by the first CCE, such as the VM environment, to be extended and applied to a second CCE, ensuring consistent security across different computing environments.

In some examples, the processing circuitry 130 is further configured to generate third attestation evidence for verifying the integrity of a second confidential computing environment based on a measurement of the second CCE and on the generated first attestation evidence. The second CCE is operating on the system software and is executed by the processing circuitry 130.

The system software (executed by the processing circuitry 130) may receive the measurement of the second CCE and verify the measurement of the second CCE, for example by comparing the hash to a predetermined and stored hash value. If the measurement of the second CCE is valid then the system software may sign the verified measurement with the third private key which may yield the third attestation evidence. Signing the measurement of the second CCE with the third private key may involve creating a digital signature for the measurement of the first CCE. That is the third private key may be used to encrypt the hash, producing a unique digital signature. The digital signature, which is the encrypted hash, ensures the authenticity and integrity of the measurement of the second CCE. This third attestation evidence is a secure, verifiable record that reflects integrity of the second CCE at a specific point in time. Because the system software's integrity is attested by the first attestation evidence, the third attestation evidence, which is generated by the system software, is also based on the generated first attestation evidence.

In some examples, generating the first attestation evidence further comprises signing the third public key of the third public-private key pair with the first private key. The third private key is used to generate the third attestation evidence as described above. The signed measurement of the second CCE may then be verified using the third public key. The third public key again is certified by the first private key, which is based on the RoT. This builds a hierarchy of trust, where all layers may be traced back to the RoT. In some examples, the TTP may comprise a seed value that is used to generate CCE-specific (TTP) key pairs. This may prevent the TTP keys being a single point of attack (per platform).

If the second CCE may comprise more than one environment, generating the third attestation evidence may comprise signing the measurement of the hierarchically lowest environment of second CCE with the third private cryptographic key of the third private-public key pair. For example, in this case the second CCE may comprise a fifth private-public key pair. In some examples, generating the third attestation evidence comprises signing a fifth public key of the fifth private-public key pair. That is, an environment of the second CCE that is hierarchically higher than the lowest environment of the first CCE may transmit measurements to the hierarchically lowest environment of the second CCE, which may then verify the measurement and sign the verified measurement with the fifth private key which may yield a fifth attestation evidence. This process may be repeated for further environments of the second CCE. This builds a hierarchy of trust, where all layers may be traced back to the RoT.

For example, the first and/or the second environment may comprise a quoting environment, a tenant environment, and a migration environment. For example, measurements of the quoting environment may be attested by the system software; measurements of the tenant environment may be attested by the quoting environment; and the measurements of the migration environment may be attested by the tenant environment.

The second confidential computing environment may be a virtual machine environment. In another example, the second confidential computing environment executed by the processing circuitry may be an enclave provided generated by the Intel® Software Guard Extensions (SGX®). SGX® provides a set of security-related instruction codes that allow applications to create secure enclaves. These enclaves are isolated regions of memory within the processing circuitry where sensitive data and code can be executed, protected from unauthorized access even by higher-privileged software such as the operating system or hypervisor. SGX enclaves ensure the confidentiality and integrity of the data and computations, making them ideal for applications requiring high security, such as financial transactions and sensitive data processing. In another example, the second confidential computing environment executed by the processing circuitry 130 may be a trusted domain generated by the Intel® Trust Domain Extensions (TDX®) may enhance the security of virtualized environment by creating trusted domains that isolate and protect virtual machines (VMs) from each other and from the underlying hypervisor. TDX® provides hardware-based mechanisms to ensure that VMs can run in a secure, isolated environment where their data and code are protected from unauthorized access and tampering.

As described above, the measurement of the second CCE may comprise a digest of the image of the CCE. That is, the measurement of the second CCE comprises a cryptographic hash of the binary executable code, configuration data, and initial state data of the second CCE or parts of the second CCE. If the second CCE comprises more than one environment, the measurement of the second CCE may refer to a measure of any of the environments. If the second CCE is an enclave, the measurement may include hashing the enclave's code, data, and execution state. If the second CCE is a trusted domain the measurement may comprise hashing the domain's memory contents, configuration, and active processes.

In some examples, the processing circuitry 130 is configured to obtain the measurement of the virtual machine environment via a microcode interface to the processing circuitry 130 which is executing the virtual machine environment. In some examples, the measurements of the virtual machine environment are collected using functions of the second confidential computing environment. In some examples, the processing circuitry 130 is configured to obtain the measurement of the virtual machine environment via a microcode interface to the processing circuitry 130 which is executing the virtual machine environment. The microcode interface may enable the processing circuitry 130 to execute specific instructions that interact directly with the hardware, ensuring precise and secure measurement collection. In some examples, the measurements of the virtual machine environment may be collected using functions of the second confidential computing environment. For example, the VM environment, or specific functions of the VM makes the second CCE to invoke a function in microcode. This function may then deliver the measurements of the VM environment.

For example, the second CCE may be the TDX (that is a trusted domain generated by the TDX). For example, the VMM of the VM environment (the QVM) makes the TDX to invoke a function in microcode to deliver the measurements of the VM environment. That is these TDX functions allow the VM environment the VMM or the quoting environment to request the microcode to scan the protected memory regions of the VM, producing a digest of the binary executable code, configuration data, and initial state data. This digest is included in a report handle generated by the microcode, which encapsulates the integrity measurements.

An advantage of this proposed technique lies in its ability to extend the attestation capability of the second CCE (for example of the TDX) to virtual machines environment by utilizing the microcode interface of the TDX for obtaining local measurements of the VM environment. This ensures precise and secure measurement collection, which is crucial for the integrity and security of the computing environment. By integrating this capability, the technique enables a unified attestation mechanism across different CCEs. That is a corresponding QE may sign measurements for any target environment (i.e., SGX enclave, TDX domain or VTX VM). A remote attestation verifier may scale better because there is a common approach to attestation evidence (attestation evidences) creation for any workload deployed to the same platform. The evidence format is consistent for all target environments (enclave, domain, VM), but the veracity may differ.

Moreover, this proposed technique leverages existing secure boot architectures to provide layered attestation for various confidential computing protection environments. This includes using TDX instructions to collect measurements from VM/VMM objects and producing authenticated local attestation reports. The hierarchical attestation mechanism ensures that each layer's public key is signed by the lower layer, creating a comprehensive and verifiable chain of trust. This approach not only enhances the security of cloud and edge applications but also allows for seamless integration and management of different computing environments, thereby offering a robust solution for maintaining the integrity and authenticity of the entire system.

For example, the existing secure/attested boot CCEs (such as TDX or SGX) may be utilized to measure the integrity of a virtual machine monitor (VMM). By leveraging a Device Identifier Composition Engine (DICE) layering approach, a unified measurement and attestation process may be applied across various CCEs, such as TDX, SGX, and VTX or the like. This approach may ensure that each layer in the boot sequence is securely measured and attested, contributing to a robust and hierarchical security framework.

In cloud and edge computing environments, applications may be run within containers for better resource utilization and scalability. These containers need to interact securely, especially when some containers might be running as virtual machine (VM) containers. By leveraging the DICE layering approach, attestation reports may be obtained for these containers, ensuring their integrity and security. This means that a container running in a cloud or edge environment may verify the trustworthiness of another container, even if it is operating within a VM. This capability is crucial for maintaining security in dynamic and distributed computing environments where different containers and VMs need to communicate and collaborate while ensuring that each maintains a high level of security and integrity.

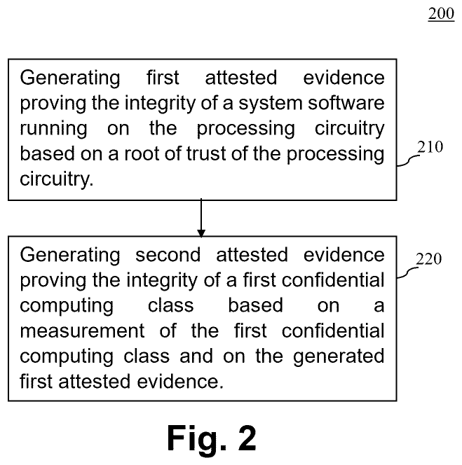

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-5).

FIG. 2 illustrates a flowchart of an example of a method 200. The method 200 may, for instance, be performed by an apparatus as described herein, such as apparatus 100. The method 200 comprises generating 210 first attestation evidence for verifying the integrity of a system software running on the processing circuitry based on a root of trust of the processing circuitry. Further, the method 200 may comprise generating 220 second attestation evidence for verifying the integrity of a first confidential computing environment based on a measurement of the first confidential computing environment and on the generated first attestation evidence. The first confidential computing environment is operating on the system software and is executed by the processing circuitry. The first confidential computing environment is a virtual machine environment

More details and aspects of the method 200 are explained in connection with the proposed technique or one or more examples described above, e.g., with reference to FIG. 2. The method 1300 may comprise one or more additional optional features corresponding to one or more aspects of the proposed technique, or one or more examples described above.

### Further Embodiments of Trusted Platforms

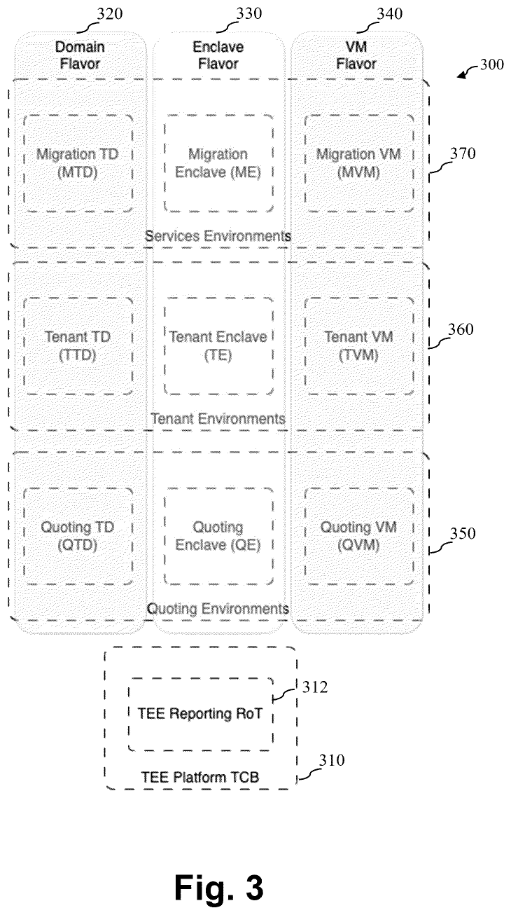

FIG. 3 illustrates a trusted platform hierarchy 300. The trusted platform hierarchy 300 comprises a TEE platform TCB (TPP) 310 which comprises a TEE reporting root of trust (ROT) 312. The trusted platform hierarchy 300 supports a common ROT architecture (TPP 310) with layered attestation. The trusted platform hierarchy 300 comprises a plurality (also referred to as different flavors) of confidential computing environments, that is the trusted domain environment (domain flavor) 320, the enclave environment (enclave flavor) 330 and the virtual machine environment (VM flavor) 340. Each of the CCEs comprises respective three environments, that is a respective quoting environment 350 (QTD, QE and QVM), a respective tenant environment 360 (TTD, TE, TVM) and a respective service environment 370 (MTD, ME, MVM). For example, the service environments 370 may specialize by hosting a migration service. The quoting environments 350 may be a special case of service environments in that other services depend on the quoting environments environment for attestation reports. The tenant environments 360 may host tenant workloads that are attested through the quoting environments 350 and tenant services are supplied by the services environments 370. The CCEs ensure the environment of isolation technology is consistent across quoting, services, and tenant environments. This ensures a weaker isolation technology isn't unexpectedly used by a tenant of a higher (more robust) CCE. However, the quoting environments may be built upon common building blocks that are from the most hardened flavor, for example the TDX.

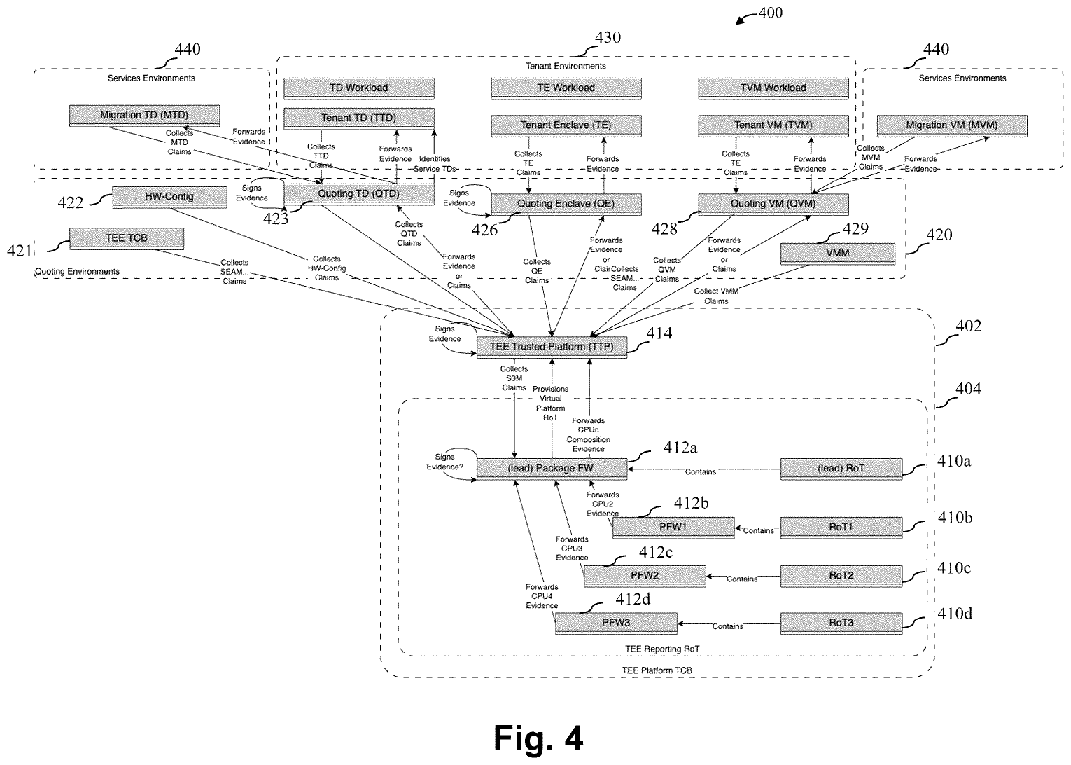

The TEE platform TCB 310 contains the TEE Reporting ROT(s) 312. This is a common building block that is hardened above the different CCEs. The TEE Platform TCB 310 contains a hardware ROT that may follow a DICE layered attestation capability. For example, it may contain multiple CPU cores, each having a hardware ROT per CPU complex (see FIG. 4). A system supporting GPUs for graphics/AI acceleration may have its own hardware RoT. For example, a GPU may be partitioned into Graphics Processing Clusters (GPC) each having several streaming multi-processor (SM) cores. The TEE Platform TCB 310, therefore may be attached to a TEE GPU TCB. Similarly, there may be a TEE IPU TCB that supports IPU clustering, offloading, and acceleration. Each TEE TCB type may support layer attestation capabilities that produce attestation evidence that describes the state of the respective TEE TCB environments.

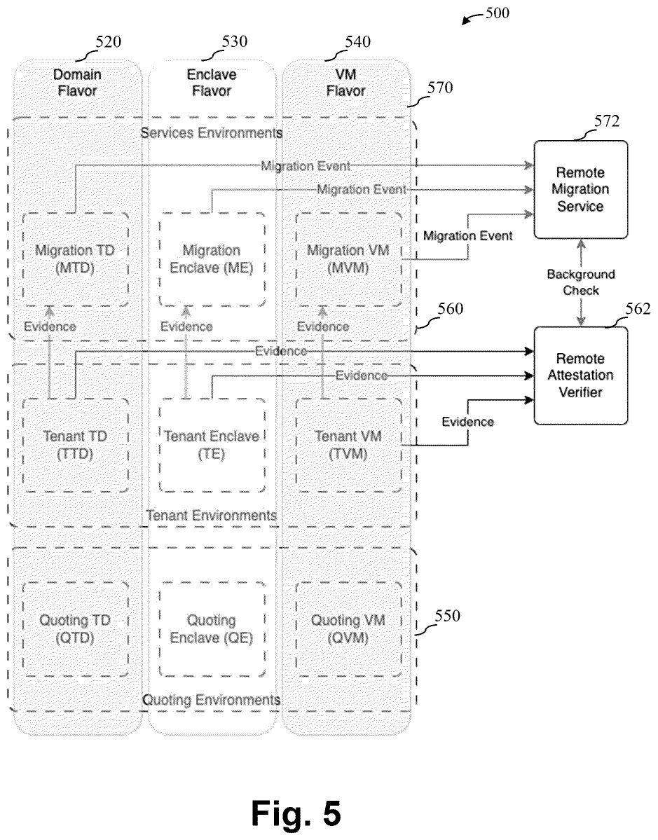

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-5).

FIG. 4 illustrates attested components within a trusted platform hierarchy 400. The trusted platform hierarchy 400 consisting of several components that are attested by a sub-component as part of a layered attestation scheme. The trusted platform hierarchy 400 comprises four CPU packages (now shown), each having a respective hardware RoT 410a (lead RoT), 410b (RoT1), 410c (RoT2) and 410d (RoT2), wherein the RoT 410a is also referred to as the lead RoT. For example, the hardware RoTs may receive a (power) reset vector that starts a layered attestation sequence. Each of the respective hardware ROT contains a respective package firmware (PFW), that is PFW 412a (lead PFW), 412b (PFW1), 412c (PFW2) and 412d (PFW3). The PFWs are attested (measured) by their respective HW RoTs. The lead PFW 412a receives the attestation evidences (evidence) from the other PFWs 412b, 412c, 412d. The lead PFW 412a may in turn attest a logical trusted platform manger 414 (also referred to as platform TEE Trusted Platform (TTP)). The TTP 414 is a common (logical) layer that supports all the CCEs (trusted execution environments), that is TTD, TE, and TVM as well as the respective quoting environments (QTD, QE, and QVM). The TTP 414 attests (measures) the building blocks used to construct the CCE-specific environments. The RoTs and the PFWs are part of the TEE reporting RoT 404, which is a part of the TEE platform PCB 402.

In some examples, all layered environments (except the QE) may depend on the QE for creating quotes. The QE is considered hardened especially for protecting and managing attestation evidence keys/quoting keys. There may be more than one QE. The QE(s) may have dedicated instructions for asking the uCode/xuCode to attest/verify the measurements about a CCE are (still) legitimate. The QE(s) are attested by lower layers like the TTP. Further, the migration TD may be in a layered environment of services IDs (not including the “Platform services enclave”) that may perform other management services beyond migration. But QE is in its own environment to ensure there isn't circular dependency of trust chains.

Further, the trusted platform hierarchy 400 comprise quoting environments 420, which comprise a respective quoting environment for each of the three CCEs. The quoting environments 420 comprise the TEE TCB 421 (for example Secure Arbitration Mode (SEAM)), HW-Config 422 and Quoting TD 423 (QTD) which are building blocks of the TDX quoting domain environment QE. Further, the quoting environments 420 comprises the quoting enclave 426 (QE) of the SGX CCE. The QE 426 is a quoting environment building block that is specific to the enclave CCE. Further, the quoting environments 420 comprise the quoting VM 428 (QVM) and the VMM 429 of the VM CCE. For each of the respective QE building blocks, the TTP 414 collects measurements as part of attestation and signs the collected measurement. For QTD, QE, and QVM, the TTP 414 forwards attestation evidence about the lower layer components (TTP, PFW(s), RoT(s)).

Further, the trusted platform hierarchy 400 comprises tenant environments 420, which comprise a respective tenant environment for each of the three CCEs, that is the TTD, TE and TVM. The respective quoting environments TTD, TE and TVM are attested by the respective quoting environment QTD, QE and QVM of the respective CCE. Further, the trusted platform hierarchy 400 comprise service environments 440, which comprise a respective migration environment for each of the three CCEs, that is the MTD, ME (not shown) and MVM. The respective migration environments MTD, ME and MVM are attested by the respective quoting environment QTD, QE and QVM of the respective CCE. That is the quoting environment quoting capability collects attestation measurements from the migration environments (respectively) and may forward attestation evidence if the migration environment needs to include it as part of performing migrations.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1 to 3) or below (e.g., FIG. 5).

FIG. 5 illustrates a remote attestation of a trusted platform hierarchy 500. As illustrated in FIG. 3, the trusted platform hierarchy 500 may comprise a TEE platform TCB (TPP) which comprises a TEE reporting root of trust (ROT) (not shown). The trusted platform hierarchy 500 support a common ROT architecture (TPP) with layered attestation. The trusted platform hierarchy 500 comprises three CCCes, that is a trusted domain environment (domain flavor) 520, the enclave environment (enclave flavor) 530 and the virtual machine environment (VM flavor) 540. Each of the CCEs comprises respective three environments, that is a respective quoting environment 550 (QTD, QE and QVM), a respective tenant environment 560 (TTD, TE, TVM) and a respective service environment 570 (MTD, ME, MVM). For example, the service environments 570 may specialize by hosting a migration service.

The tenant environments 560 may produce attestation evidence (attestation evidences) for the CCE-specific tenant endpoint. In some cases, the CCE isolation mechanisms may prevent cross-CCE interactions, hence it is unusual for a lead attester to broker connections across CCE boundaries. A remote attestation verifier 562 may create CCE-specific connections to a respective tenant environment (e.g., TTD, TE, or TVM). Further, the services environment 570 such as a migration service may use attestation evidence during migration to identify security, privacy, and other properties of the to-be-migrated workload so that a remote migration service may configure the migration target environment to be the same (or similar—as specified by a migration policy) as the source environment. The remote migration service 572 may validate the attestation evidences using a background check model to ensure evidence is valid. The measurements in this example, may be the measurement of a TEE image that was loaded, the key that signed dynamically loaded modules following the initial image called and/or other code/settings used by the workload within the CCE (these measurements are also referred to as run time measured resources). For a given attestation endpoint (that is the lead attester that communicates with the attestation verifier/service), there is a chain of evidence that traverses the platform to its RoT(s). Evidence chains may be implemented using evidence chaining standards such as described in the specification “Remote Attestation Procedures”, by H. Birkholz, N. Smith, T. Fossati, H. Tschofenig, 1 Jul. 2024 or in the specification “DICE Attestation Architecture” by the Trusted Computing Group, Version 1.1, Revision 0.18, Jan. 6, 2024.

Due to the common standards-based attestation mechanism (TTP) regardless of CCE the remote attestation verifier 562 may verify evidence of each of the different CCEs because there isn't a different attestation sub-system that is CCE-specific for a given platform.

Further details and aspects are mentioned in connection with the examples described above. The example shown in FIG. 5 may include one or more optional additional features corresponding to one or more aspects mentioned in connection with the proposed concept or one or more examples described above (e.g., FIGS. 1 to 4).

In the following, some examples of the proposed technique are presented:

An example (e.g., example 1) relates to an apparatus comprising interface circuitry, machine-readable instructions and processing circuitry to execute the machine-readable instructions to generate first attestation evidence based on a measurement of a system software proving the integrity of a system software running on the processing circuitry based on a root of trust of the processing circuitry, generate second attestation evidence for verifying the integrity of a first confidential computing environment based on a measurement of the first confidential computing environment and on the generated first attestation evidence, wherein the first confidential computing environment is operating on the system software and is executed by the processing circuitry, and wherein the first confidential computing environment is a virtual machine environment.

Another example (e.g., example 2) relates to a previous example (e.g., example 1) or to any other example, further comprising that the processing circuitry is further to execute the machine-readable instructions to generate third attestation evidence for verifying the integrity of a second confidential computing environment based on a measurement of the second confidential computing environment and on the generated first attestation evidence, wherein the second confidential computing environment is operating on the system software and is executed by the processing circuitry.

Another example (e.g., example 3) relates to a previous example (e.g., example 2) or to any other example, further comprising that the second confidential computing environment executed by the processing circuitry is an enclave and/or a trusted domain.

Another example (e.g., example 4) relates to a previous example (e.g., one of the examples 1 to 3) or to any other example, further comprising that generating the first attestation evidence comprises signing the measurement of the system software with a first private key, the first private key being based on the root of trust of the processing circuitry.

Another example (e.g., example 5) relates to a previous example (e.g., example 4) or to any other example, further comprising that generating the first attestation evidence comprises signing a second public key of a second public-private key pair with the first private key.

Another example (e.g., example 6) relates to a previous example (e.g., one of the examples 1 to 5) or to any other example, further comprising that generating the second attestation evidence comprises signing the measurement of the virtual machine environment with a second private key of a second private-public key pair.

Another example (e.g., example 7) relates to a previous example (e.g., example 6) or to any other example, further comprising that generating the second attestation evidence comprises signing a fourth public key of a fourth private-public key pair.

Another example (e.g., example 8) relates to a previous example (e.g., one of the examples 2 or 7) or to any other example, further comprising that generating the third attestation evidence comprises signing the measurement of the second confidential computing environment with a third cryptographic key of a third private-public key pair.

Another example (e.g., example 9) relates to a previous example (e.g., example 8) or to any other example, further comprising that generating the first attestation evidence comprises signing the third public key of the third public-private key pair with the first private key.

Another example (e.g., example 10) relates to a previous example (e.g., one of the examples 8 or 9) or to any other example, further comprising that generating the third attestation evidence comprises signing a fifth public key of a fifth public-private key pair, with the third private key.

Another example (e.g., example 11) relates to a previous example (e.g., one of the examples 1 to 10) or to any other example, further comprising that the processing circuitry is further to execute the machine-readable instructions to obtain the measurement of the virtual machine environment via a microcode interface to the processing circuitry executing the virtual machine environment.

Another example (e.g., example 12) relates to a previous example (e.g., one of the examples 1 to 11) or to any other example, further comprising that the measurements of the virtual machine environment are collected using instructions of the second confidential computing environment.

Another example (e.g., example 13) relates to a previous example (e.g., one of the examples 1 to 12) or to any other example, further comprising that a measurement of the first and/or second attestation evidence comprise a hash value of a software, a signature, configuration data, telemetry data and/or inference data.

Another example (e.g., example 14) relates to a previous example (e.g., one of the examples 1 to 13) or to any other example, further comprising that the measurement of the first and/or second confidential computing environment comprise data about a state, behavior, and/or configuration of one or more layered environments of the respective first and/or second confidential computing environment.

Another example (e.g., example 15) relates to a previous example (e.g., one of the examples 2 to 14) or to any other example, further comprising that the processing circuitry is further to execute the machine-readable instructions to transmit the first and/or second attestation evidence to an external verifier, wherein the verifier is verifying the first and/or second attestation evidence.

Another example (e.g., example 16) relates to a previous example (e.g., one of the examples 1 to 15) or to any other example, further comprising that the system software comprises a trusted platform manager.

Another example (e.g., example 17) relates to a previous example (e.g., one of the examples 2 to 16) or to any other example, further comprising that the first and/or the second confidential computing environment comprises one or more layered environments.

Another example (e.g., example 18) relates to a previous example (e.g., example 17) or to any other example, further comprising that the one or more layered environments of the first and/or second confidential computing environment comprise at least one of a quoting environment, a tenant environment, or a service environment.

An example (e.g., example 19) relates to a method comprising generating first attestation evidence based on a measurement of a system software proving the integrity of a system software running on the processing circuitry based on a root of trust of the processing circuitry, generating second attestation evidence for verifying the integrity of a first confidential computing environment based on a measurement of the first confidential computing environment and on the generated first attestation evidence, wherein the first confidential computing environment is operating on the system software and is executed by the processing circuitry, and wherein the first confidential computing environment is a virtual machine environment.

Another example (e.g., example 20) relates to a previous example (e.g., example 19) or to any other example, further comprising generating third attestation evidence for verifying the integrity of a second confidential computing environment based on a measurement of the second confidential computing environment and on the generated first attestation evidence, wherein the second confidential computing environment is operating on the system software and is executed by the processing circuitry.

Another example (e.g., example 21) relates to a previous example (e.g., example 20) or to any other example, further comprising that the second confidential computing environment executed by the processing circuitry is an enclave and/or a trusted domain.

Another example (e.g., example 22) relates to a previous example (e.g., one of the examples 19 to 21) or to any other example, further comprising that generating the first attestation evidence comprises signing the measurement of the system software with a first private key, the first private key being based on the root of trust of the processing circuitry.

Another example (e.g., example 23) relates to a previous example (e.g., example 22) or to any other example, further comprising that generating the first attestation evidence comprises signing a second public key of a second public-private key pair with the first private key.

Another example (e.g., example 24) relates to a previous example (e.g., one of the examples 19 to 23) or to any other example, further comprising that generating the second attestation evidence comprises signing the measurement of the virtual machine environment with a second private key of a second private-public key pair.

Another example (e.g., example 25) relates to a previous example (e.g., example 24) or to any other example, further comprising that generating the second attestation evidence comprises signing a fourth public key of a fourth private-public key pair.

Another example (e.g., example 26) relates to a previous example (e.g., one of the examples 20 or 25) or to any other example, further comprising that generating the third attestation evidence comprises signing the measurement of the second confidential computing environment with a third cryptographic key of a third private-public key pair.

Another example (e.g., example 27) relates to a previous example (e.g., example 26) or to any other example, further comprising that generating the first attestation evidence comprises signing the third public key of the third public-private key pair with the first private key.

Another example (e.g., example 28) relates to a previous example (e.g., one of the examples 26 or 27) or to any other example, further comprising that generating the third attestation evidence comprises signing a fifth public key of a fifth public-private key pair, with the third private key.

Another example (e.g., example 29) relates to a previous example (e.g., one of the examples 19 to 28) or to any other example, further comprising obtaining the measurement of the virtual machine environment via a microcode interface to the processing circuitry executing the virtual machine environment.

Another example (e.g., example 30) relates to a previous example (e.g., one of the examples 19 to 29) or to any other example, further comprising that the measurements of the virtual machine environment are collected using instructions of the second confidential computing environment.

Another example (e.g., example 31) relates to a previous example (e.g., one of the examples 19 to 30) or to any other example, further comprising that a measurement of the first and/or second attestation evidence comprise a hash value of a software, a signature, configuration data, telemetry data and/or inference data.

Another example (e.g., example 32) relates to a previous example (e.g., one of the examples 19 to 31) or to any other example, further comprising that the measurement of the first and/or second confidential computing environment comprise data about a state, behavior, and/or configuration of one or more layered environments of the respective first and/or second confidential computing environment.

Another example (e.g., example 33) relates to a previous example (e.g., one of the examples 20 to 32) or to any other example, further comprising transmitting the first and/or second attestation evidence to an external verifier, wherein the verifier is verifying the first and/or second attestation evidence.

Another example (e.g., example 34) relates to a previous example (e.g., one of the examples 19 to 33) or to any other example, further comprising that the system software comprises a trusted platform manager.

Another example (e.g., example 35) relates to a previous example (e.g., one of the examples 20 to 34) or to any other example, further comprising that the first and/or the second confidential computing environment comprises one or more layered environments.

Another example (e.g., example 36) relates to a previous example (e.g., example 35) or to any other example, further comprising that the one or more layered environments of the first and/or second confidential computing environment comprise at least one of a quoting environment, a tenant environment, or a service environment.

An example (e.g., example 37) relates to an apparatus comprising processor circuitry configured to generate first attestation evidence based on a measurement of a system software proving the integrity of a system software running on the processing circuitry based on a root of trust of the processing circuitry, generate second attestation evidence for verifying the integrity of a first confidential computing environment based on a measurement of the first confidential computing environment and on the generated first attestation evidence, wherein the first confidential computing environment is operating on the system software and is executed by the processing circuitry, and wherein the first confidential computing environment is a virtual machine environment.

An example (e.g., example 38) relates to a device comprising means for processing for generating first attestation evidence based on a measurement of a system software proving the integrity of a system software running on the processing circuitry based on a root of trust of the processing circuitry, generating second attestation evidence for verifying the integrity of a first confidential computing environment based on a measurement of the first confidential computing environment and on the generated first attestation evidence, wherein the first confidential computing environment is operating on the system software and is executed by the processing circuitry, and wherein the first confidential computing environment is a virtual machine environment.

Another example (e.g., example 39) relates to a non-transitory machine-readable storage medium including program code, when executed, to cause a machine to perform the method of any one of examples 19 to 36.

Another example (e.g., example 40) relates to a computer program having a program code for performing the method of any one of examples 19 to 36 when the computer program is executed on a computer, a processor, or a programmable hardware component.

Another example (e.g., example 41) relates to a machine-readable storage including machine readable instructions, when executed, to implement a method or realize an apparatus as claimed in any pending examples.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network class. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
generate first attestation evidence based on a measurement of a system software proving the integrity of the system software running on the processing circuitry based on a root of trust of the processing circuitry;
generate second attestation evidence for verifying the integrity of a first confidential computing environment based on a measurement of the first confidential computing environment and on the generated first attestation evidence,
wherein the first confidential computing environment is operating on the system software and is executed by the processing circuitry, and wherein the first confidential computing environment is a virtual machine environment.

2. The apparatus of claim 1, wherein the processing circuitry is further to execute the machine-readable instructions to generate third attestation evidence for verifying the integrity of a second confidential computing environment based on a measurement of the second confidential computing environment and on the generated first attestation evidence, wherein the second confidential computing environment is operating on the system software and is executed by the processing circuitry.

3. The apparatus of claim 2, wherein the second confidential computing environment executed by the processing circuitry is an enclave and/or a trusted domain.

4. The apparatus of claim 1, wherein generating the first attestation evidence comprises signing the measurement of the system software with a first private key, the first private key being based on the root of trust of the processing circuitry.

5. The apparatus of claim 4, wherein generating the first attestation evidence comprises signing a second public key of a second public-private key pair with the first private key.

6. The apparatus of claim 1, wherein generating the second attestation evidence comprises signing the measurement of the virtual machine environment with a second private key of a second private-public key pair.

7. The apparatus of claim 6, wherein generating the second attestation evidence comprises signing a fourth public key of a fourth private-public key pair.

8. The apparatus of claim 1, wherein generating the third attestation evidence comprises signing the measurement of the second confidential computing environment with a third cryptographic key of a third private-public key pair.

9. The apparatus of claim 8, wherein generating the first attestation evidence comprises signing the third public key of the third public-private key pair with the first private key.

10. The apparatus of claim 8, wherein generating the third attestation evidence comprises signing a fifth public key of a fifth public-private key pair, with the third private key.

11. The apparatus of claim 1, wherein the processing circuitry is further to execute the machine-readable instructions to obtain the measurement of the virtual machine environment via a microcode interface to the processing circuitry executing the virtual machine environment, and/or wherein the measurements of the virtual machine environment are collected using instructions of the second confidential computing environment.

12. The apparatus of claim 1, wherein the measurements of the virtual machine environment comprise measurements of the virtual machine monitor managing a virtual machine of the virtual machine environment.

13. The apparatus of claim 1, wherein a measurement of the first and/or second attestation evidence comprises a hash value of a software, a signature, configuration data, telemetry data and/or inference data.

14. The apparatus of claim 1, wherein the measurement of the first and/or second confidential computing environment comprise data about a state, behavior, and/or configuration of one or more layered environments of the respective first and/or second confidential computing environment.

15. The apparatus of claim 2, wherein the processing circuitry is further to execute the machine-readable instructions to transmit the first and/or second attestation evidence to an external verifier, wherein the verifier is verifying the first and/or second attestation evidence.

16. The apparatus of claim 1, wherein the system software comprises a trusted platform manager.

17. The apparatus of claim 2, wherein the first and/or the second confidential computing environment comprises one or more layered environments.

18. The apparatus of claim 17, wherein the one or more layered environments of the first and/or second confidential computing environment comprise at least one of a quoting environment, a tenant environment, and a service environment.

19. A method comprising:
generating first attestation evidence based on a measurement of a system software proving the integrity of a system software running on the processing circuitry based on a root of trust of the processing circuitry;
generating second attestation evidence for verifying the integrity of a first confidential computing environment based on a measurement of the first confidential computing environment and on the generated first attestation evidence,
wherein the first confidential computing environment is operating on the system software and is executed by the processing circuitry, and wherein the first confidential computing environment is a virtual machine environment.

20. A non-transitory machine-readable storage medium including program code, when executed, to cause a machine to perform the method of claim 19.
